(19) United States
(12) Patent Application Publication
(10) Pub. No.: US 2003/0091777 A1
(43) Pub. Date: May 15, 2003

(54) Clean release tape for EMI shielding

(76) Inventors: Peter Jones, Londonderry, NH (US); Deanna J. Wright, Wilmington, MA (US); Robert J. Malik, Hudson, NH (US)

Correspondence Address: John A. Molnar, Jr., PARKER-HANNIFIN CORPORATION, 6035 Parkland Boulevard, Cleveland, OH, 44124-4141, US

(21) Appl. No.: 10/176,980

(22) Filed: Jun. 20, 2002

Related U.S. Application Data
(60) Provisional application No. 60/312,307, filed on Aug. 14, 2001.

(51) Int. Cl. B32B 9/00

(52) U.S. Cl. 428/40.1; 428/57

(57) ABSTRACT

An EMI shielding tape adherable to a surface of a structure. The tape includes a backing layer, and an adhesive layer carried on at least one side of the backing layer. The adhesive layer has an inner face bonded the backing layer, and an opposite outer face which is bondable under pressure to the structure surface to adhere the tape thereto. The adhesive layer is formulated as an admixture of a pressure sensitive adhesive (PSA) composition and one or more electrically-conductive particulate fillers. When adhered to the structure surface, the tape is substantially cleanly releasable therefrom.

### CROSS-REFERENCE TO RELATED CASES

The present application claims the benefit of the filing date of U.S. Provisional Application Serial No. 60/312,307; filed Aug. 14, 2001, the disclosure of which is expressly incorporated herein by reference.

### BACKGROUND OF THE INVENTION

The present invention relates broadly to electrically-conductive, pressure-sensitive adhesive tapes for providing electromagnetic interference (EMI) shielding and dust or other environmental sealing of seams along cases, housing, and other enclosures for electronic devices, and particularly to a tape which is cleanly releasable to be removable and/or repositionable for allowing access to the interior of the enclosure for rework, repair, or other disassembly, and for allowing reassembly without the need to clean adhesive residue from the seam.

The operation of electronic devices such as televisions, radios, computers, medical instruments, business machines, communications equipment, and the like is attended by the generation of electromagnetic radiation within the electronic circuitry of the equipment. As is detailed in U.S. Pat. Nos. 5,202,536; 5,142,101; 5,105,056; 5,028,739; 4,952,448; and 4,857,668, such radiation often develops as a field or as transients within the radio frequency band of the electromagnetic spectrum, i.e., between about 10 KHz and 10 GHz, and is termed “electromagnetic interference” or “EMI” as being known to interfere with the operation of other proximate electronic devices.

To attenuate EMI effects, shielding having the capability of absorbing and/or reflecting EMI energy may be employed both to confine the EMI energy within a source device, and to insulate that device or other “target” devices from other source devices. Such shielding is provided as a barrier which is interposed between the source and the other devices, and typically is configured as an electrically conductive and grounded case, housing, cabinet, or other enclosure of the device.

The enclosure may be formed of a metal such as steel, aluminum, or magnesium, or alternatively, of a plastic or other polymeric material which is loaded with a metal or other electrically-conductive filler or which is provided with a metal or other conductive layer fastened, over-molded, spray painted, dip coated, clad, electrolessly or electrolytically plated, thermal or vacuum metallized, or otherwise generally applied or deposited across the interior surfaces of the housing. The conductive layer may be an electrically-conductive paint, a conductively-filled, molded elastomeric layer, a metal foil laminate, transfer, or liner, a metal plating, or a flame, arc, or other thermally-sprayed metal. Such housings and methods are further described in commonly-assigned U.S. Pat. No. 5,566,055, in DE 19728839, U.S. Pat. Nos. 5,847,317; 5,811,050; 5,442,153; 5,180,639; 5,170,009; 5,150,282; 5,047,260; 4,714,623; and WO 00/29635; 99/43191; 99/40769; 98/54942; 98/47340; 97/26782, and in the following publications of the Chomerics Division of Parker Hannifin Corporation (Woburn, Mass.): “CHO-SHIELD® Conductive Compounds;” “CHO-SHIELD® EMI Shielding Covers,” Technical Bulletin 22, (1996); “CHO-VER SHIELD™ EMI Shielding Plastic Cover with Molded Conductive Elastomeric Gasket,” (1999); “CHO-SHIELD® 2052 Conductive Coating,” Technical Bulletin 48, (2000); “CHO-SHIELD® 2054 Conductive Coating,” Preliminary Product Data Sheet, (2000); and “CHO-SHIELD® 2056 High Performance Conductive Coating,” Preliminary Product Data Sheet.

A conductive gasket may be used to provide electrical continuity across seams formed between mating parts of the enclosure such as between a door, hatch, panel, or cover and a mating other part of the enclosure. Alternatively, for many applications, an electrically-conductive, pressure-sensitive adhesive EMI shielding tape is used to cover the seam for providing electrical continuity thereacross and for providing environmental sealing against dust and other contaminates. Such tapes may be formed of a sheet stock, film stock, foil, or other substrate or “backing” on which is coated a facing of a layer of a pressure-sensitive adhesive. The substrate typically is a copper, aluminum, tinned-copper, or other metal foil, a polyester, e.g., Mylar® (DuPont, Wilmington, Del.), or other plastic film sheet, or a polyester or other synthetic fiber cloth which may be plated with nickel, nickel over silver, tin over copper, or another plating. The adhesive typically is silicone or acrylic-based, and may be loaded with an electrically-conductive filler such as silver or other metal or metal-plated particles. EMI shielding tapes of the type herein involved are marketed commercially under the names “CHO-FAB™” and “CHO-FOIL®” by the Chomerics Division of Parker Hannifin Corporation (Woburn, Mass.).

One such application for EMI shielding tapes involves the sealing of enclosures for magnetic disk storage devices or “disk drives,” as they are more commonly known, for personal computers and the like. In this regard, the mechanical and electromechanical components of the drive typically are integrated within a housing which provides a substantially hermetic environment for the proper functioning of the components. The housing typically includes a base on which the heads, actuator, motor and other drive components are mounted, and a cover which encloses the base. The cover and base, either or both of which may be formed as having side walls, meet along a interface which, in turn, defines a seam which extends about the perimeter of the housing. As is further described, for example, in U.S. Pat. Nos. 5,673,157; 5,270,887; 5,267,577; 5,021,905, this seam may be sealed by means of a length of an EMI shielding tape of the type described hereinbefore which is adhered to the external surfaces of the base and cover along the seam.

It is believed, however, that the EMI shielding tapes heretofore employed in the sealing of housings for disk drives and other electronic devices have not been considered to be removable or repositionable. That is, upon being removed for repair, rework, or other disassembly of the drive, the tapes did not release cleanly from the surfaces of the housing parts, but instead, whether as a result of initial adhesion or a build on aging, left an adhesive residue thereon. Such residue generally necessitated that the housing surface be scrapped, solvent-wiped, or otherwise cleaned of the residue prior to reassembly.

As electronic devices continue to proliferate, it will be appreciated that additional EMI shielding options and/or alternatives would be well-received by the electronics industry. In this regard, it is believed that for certain applications, such as for the sealing of disk drive housings, especially desired would be a tape which is both electrically conductive to provide EMI shielding and which is cleanly releasable after service from the surface of the housing for repair, rework, repositioning, or other disassembly.

### BROAD STATEMENT OF THE INVENTION

The present invention is directed to an electrically-conductive, pressure-sensitive adhesive tape for providing electromagnetic interference (EMI) shielding and dust or other environmental sealing of seams along cases, housing, and other enclosures for electronic devices. Particularly, the invention is directed to such a tape which is cleanly releasable so as to be readily removable and/or repositionable for allowing access to the interior of the enclosure for rework, repair, or other disassembly, and for allowing reassembly without the need to clean adhesive residue from the seam.

In an illustrative embodiment especially suited for housings and other enclosures for disk drive and other electronic devices, the EMI shielding tape of the invention includes a pressure-sensitive adhesive (PSA) surface which may be provided as a layer of an aqueous emulsion or solvent-based PSA formulation. Such formulation may be rendered conductive via its loading with an electrically-conductive particulate filler such as silver-coated copper particles. The PSA layer is coated onto at least one side of a backing or other substrate which also may be electrically conductive. In this regard, such substrate may be provided as a strip, sheet, or other layer of a copper, aluminum, tinned-copper, or other metal foil, or a polyester or other synthetic fiber cloth plated with nickel, nickel over silver, tin over copper, or another metal plating. The tape so formed may be supplied in a sheet or roll form.

In use, the tape may be applied manually or using automated equipment to cover a seam, which may be internal or external, between adjoining parts, such as between a base and a cover of a housing or other enclosure for an electronic device. In this regard, with the PSA surface of the tape being bonded across the seam to each of the adjoining housing parts, electrical continuity may be provided across the seam for the EMI shielding of the device. The tape also may provide environmental sealing of the housing from dust and other contaminants. Advantageously, however, the adhesive is formulated to be cleanly releasable from the surfaces of the housing parts, which may be formed of a metal such as steel, aluminum, or magnesium, metal-plated, or of a plastic or other polymeric material which is loaded with a metal or other electrically-conductive filler or which is provided with a metal, metal-filled, or other conductive layer. By “cleanly releasable,” it is meant that the tape may be removed from the housing surfaces under a moderate peel force of about 1-10 lb/in (179-1790 g/cm) while exhibiting a primarily adhesive failure from those surfaces so as to leave substantially no adhesive residue thereon.

The present invention, accordingly, comprises the combination of elements and arrangement of parts and steps which are exemplified in the detailed disclosure to follow. Advantages of the present invention include an EMI shielding tape which may be used for sealing seams within disk drive housings and other enclosures, but which also is cleanly releasable from the metal, metal-filled, and other surfaces of the enclosures for rework, repair, or other disassembly. Still other advantages include a clean release EMI shielding tape which is adherable to metal housings and other substrates without an appreciable build on aging. These and other advantages will be readily apparent to those skilled in the art based upon the disclosure contained herein.

### BRIEF DESCRIPTION OF THE DRAWING

For a fuller understanding of the nature and objects of the invention, reference should be had to the following detailed description taken in connection with the accompanying drawing wherein:

FIG. 1 is a perspective view of a representative embodiment of the electrically-conductive, clean-release, pressure-sensitive adhesive EMI shielding tape of the present invention, the view being shown with sections being removed away to better reveal the construction of the tape;

FIG. 2 is a magnified cross-sectional view taken through line 2-2 of FIG. 1 showing the construction of the clean-release tape thereof in enhanced detail; and

FIG. 3 is a perspective view of a representative EMI shielding assembly illustrative of an application of the EMI shielding tape of the present invention.

The drawings will be described further in connection with the following Detailed Description of the Invention.

### DETAILED DESCRIPTION OF THE INVENTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “interior,” “inner,” or “inboard” and “outward,” “exterior,” “outer,” or “outboard” referring, respectively, to directions toward and away from the center of the referenced element, and the terms “radial” or “horizontal” and “axial” or “vertical” referring, respectively, to directions, axes, planes perpendicular and parallel to the central longitudinal axis of the referenced element. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

For the illustrative purposes of the discourse to follow, the precepts of the electrically-conductive, pressure-sensitive adhesive (PSA) tape herein involved are described in connection with its use to cover seams, such as between a cover and a base part of a housing or other enclosure for a disk drive or other electronic device, for providing EMI shielding and environmental sealing of the enclosure. As used herein, the term “EMI shielding” should be understood to include, and to be used interchangeably with, electromagnetic compatibility (EMC), surface grounding, corona shielding, radio frequency interference (RFI) shielding, and anti-static, i.e., electro-static discharge (ESD) protection. In view of the discourse to follow, however, it will be appreciated that aspects of the present invention may find utility in other applications requiring an electrically-conductive PSA tape. Use within those such other applications therefore should be considered to be expressly within the scope of the present invention.

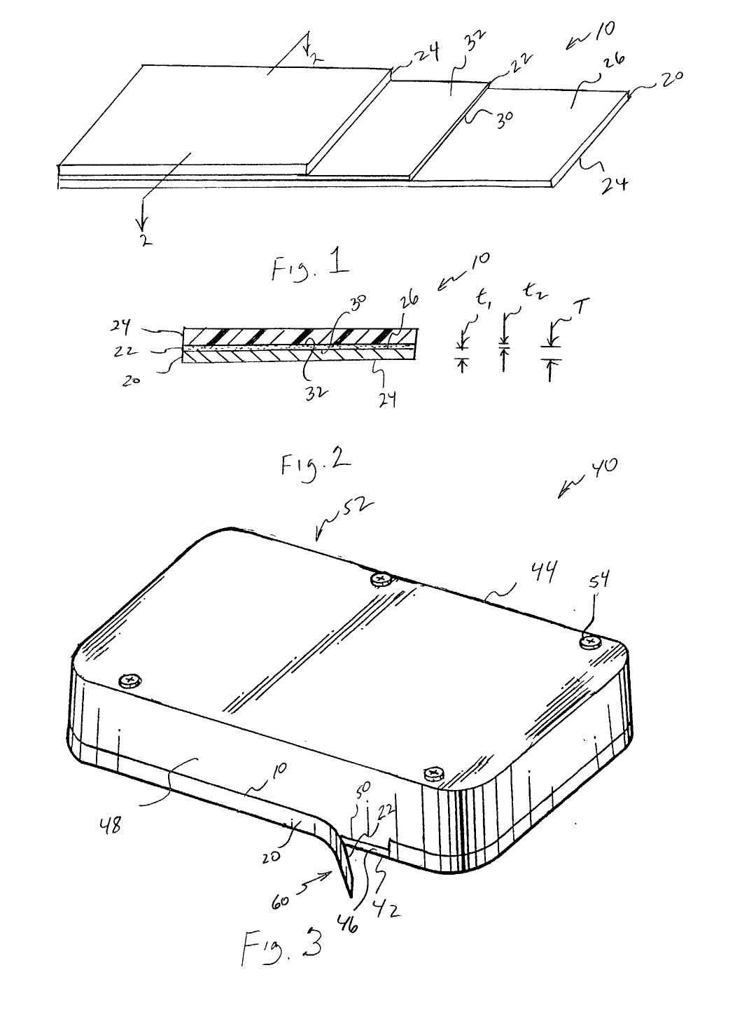

Referring then to the figures wherein corresponding reference characters are used to designate corresponding elements throughout the several views with equivalent elements being referenced with prime or sequential alphanumeric designations, a representative tape construction in accordance with the present invention is shown generally at 10 in perspective in FIG. 1 and in cross-section in FIG. 2. Within an EMI shielding enclosure or other assembly (FIG. 3), tape 10 may be used, for example, to cover a seam, which may be internal or external, between adjoining surfaces of the enclosure such as between a base and cover.

Tape 10, which may have an overall thickness, referenced at “T” in the cross-sectional view of FIG. 2, of between about 1.0-10.5 mils (0.025-0.267 mm), may be provided in the form of, or as formed from, a sheet, roll, tape, die-cut part, or the like. In basic construction, tape 10, which may be of an indefinite length and/or width, is a laminate of a backing strip, sheet, or other generally flat layer, 20, an adhesive layer, 22, which is coated or otherwise carried on at least one side, or portion thereof, of the backing layer 20, and, optionally, a release liner, 24, for covering the adhesive layer 22 during shipping and handling. For most applications, backing layer 20 with have thickness, referenced at “t₁” in FIG. 2, of between about 0.5-8 mils (0.013-0.203 mm), with adhesive layer 22 having a thickness, referenced at “t₂” in FIG. 2, of between about 0.5-2.5 mils (0.013-0.064 mm).

As is shown in the different views of FIGS. 1 and 2, backing layer 20 has a first side or surface, 24, and an opposing second side or surface, 26, which defines the thickness dimension t₁ of the layer therebetween. Adhesive layer 22 may be coated or laminated on, or otherwise bonded to or made integral with the second side 26 of the backing layer 20 to provide the laminar structure of tape 10. Although adhesive layer 22 is shown in the views of FIGS. 1 and 2 as being coated on only one side of the backing layer 20, it will be appreciated that, depending upon the intended application, a second adhesive layer 22 may be coated on the backing layer first side 24. Similarly, although adhesive layer 22 is shown to be coated on substantially the entirety of the backing layer second side 26, the layer 22 alternatively may be applied in a pattern or otherwise to cover only a portion of the side 26. As coated or otherwise carried on the backing layer second side 26, adhesive layer 22 has an inner face, 30, which is adhesively or otherwise bonded to the second side 26, and an opposite outer face, 32, which is adhesively bondable under an applied pressure to the surface or surfaces of the enclosure part in the manner to be detailed hereinafter in connection with FIG. 3.

Backing layer 20 may be a formed of any synthetic, natural, or glass fiber fabric, or any paper or foamed or unfoamed plastic, resin, elastomer, or other polymeric or other material conventionally used in tape construction. However, it may be preferred for many EMI shielding applications that the layer 20 be formed of an electrically-conductive material which may be a metal foil such as copper, aluminum, or tinned-copper. Alternatively, a polyester or other synthetic fiber cloth plated with nickel, nickel over silver, tin over copper, or other metal plating may be substituted.

Adhesively layer 22, in turn, may be formulated as a blend or other admixture of a pressure-sensitive adhesive (PSA) composition and one or more electrically-conductive, particulate fillers. The term “PSA” is used herein in its conventional sense to mean that the composition is formulated as having a glass transition temperature, surface energy, and/or other properties such that it exhibits some degree of tack at normal room temperature. That is, the constituent polymers and/or copolymers of the composition generally will have a glass transition temperature of less than about 0° C. such that the mass of the composition is tacky at ambient temperatures and is thereby bondable under an applied pressure to a surface or other substrate. In general, the formulation of the adhesive composition specifically may be selected to exhibit an affinity, as may be measured by lap shear, die shear, static or dynamic shear, peel, or other adhesion, to the material forming the substrate or substrates involved in the particular application, but which affinity is less than to the material forming the backing layer 20. Such adhesion affinities may depend particularly on the surface energy of the materials involved, and may be developed from surface tension, valence, polar, electrostatic, van der Waals, or other attractive forces, mechanical interlocking action, or a combination thereof.

In this regard, should similar materials of construction be specified in the particular application for the substrate and backing layer, the backing layer second side 26 may be coated, prior to the application of the adhesive layer, with a higher surface energy “tie” layer so as to increase the affinity of the adhesive layer 22 thereto relative to the substrate surface. Such tie layer may be formed as a chemical bond coat, such as a thermoplastic dissolved in a solvent, which is applied to the side 26 and dried or otherwise cured thereon to form an intermediate tie layer between the side and the adhesive layer 22. Alternatively, other known surface treatments may employed such as cleaning or roughening the side 26 with one or more of compressed gas, chemical or solvent etching/cleaning, grit-blasting, such as with aluminum oxide or other abrasive, or plasma, such as may be generated from the ionization of oxygen, argon, or another gas or mixture of gases.

Typically, the tape 10 of the invention will be bondable to the substrate surface under firm hand pressure, and will exhibit thereon a 180° peel adhesion, such as may be determined in accordance with PSTC-1 (Pressure Sensitive Tape Council Test Methods for Pressure Sensitive Adhesive Tapes, Pressure Sensitive Tape Council, Northbrook, Ill. 60062), of between about 1.5-5.0 lb/in (0.26-0.87 N/m) initial. Preferably, such adhesion will be observed to increase or “build” on aging by less than about 50%.

The PSA composition itself may be formulated as an admixture, blend, or copolymer of one or more PSA components. Components which may be useful in tape 10 of the present invention may include any PSA material to the extent that such material is cleanly releasable in the manner to be described hereinafter from the surface of the substrate to which it is adhered. In a particularly preferred embodiment, the pressure-sensitive adhesive composition, which may be a homopolymer, copolymer, or terpolymer, or an interpenetrating network or blend of different homopolymers, copolymers, and/or terpolymers, is based on one or more acrylic PSA materials which may derived from acrylic and/or methacrylic acid, and/or an ester, amide, or nitrile derivative thereof. Examples of such materials include acrylic acid, methacrylic acid, isooctylacrylate, isobornylacrylate, 2-ethylhexylacrylate, isoamylacrylate, nonylacrylate, butylacrylate, acrylamide, methacrylamide, acrylonitrile, and methacrylonitrile. The PSA composition also may be compounded with a tackifying resin by which the adhesive properties thereof may be tailored to a specific application. Tackifiers for acrylic PSA materials are well known in the art, and are described, for example, in Handbook of Pressure Sensitive Adhesives (Satas, ed.), Second Ed., 1989, pp. 567-600.

Alternatively, the PSA composition may be based on a natural or synthetic rubber or elastomer, or other resin, plastic, or polymer exhibiting rubber-like properties of compliancy, resiliency or compression deflection, low compression set, flexibility, and an ability to recover after deformation. Examples of these such materials include styrene butadienes, styrene isoprenes, polybutadienes, polyisobutylenes, polyurethanes, silicones, fluorosilicones and other fluoropolymers, Hevea, chlorosulfonates, buna-N, butyls, neoprenes, nitriles, polyisoprenes, plasticized nylons, polyesters, polyvinyl ethers, polyvinyl acetates, polyisobutylenes, ethylene vinyl acetates, polyolefins, and polyvinyl chlorides, copolymer rubbers such as ethylene-propylene (EPR), ethylene-propylene-diene monomer (EPDM), styrene-isoprene-styrene (SIS), styrene-butadiene-styrene (SBS), nitrile-butadienes (NBR) and styrene-butadienes (SBR), blends such as ethylene or propylene-EPDM, EPR, or NBR, and mixtures, blends, and copolymers thereof. These materials likewise may be compounded with a tackifier which may be a resin such as glyceryl esters of hydrogenated resins, thermoplastic terpene resins, petroleum hydrocarbon resins, coumarone-indene resins, synthetic phenol resins, low molecular weight polybutenes, or a tackifying silicone. Generally, the tackifying resin may be compounded into the resin material at between about 40-150 parts per hundred parts of the resin.

The PSA composition generally forms a binder into which the electrically-conductive filler is dispersed. Suitable electrically-conductive fillers include: noble and non-noble metals such as nickel, copper, tin, aluminum, and nickel; noble metal-plated noble or non-noble metals such as silver-plated copper, nickel, aluminum, tin, or gold; non-noble metal-plated noble and non-noble metals such as nickel-plated copper or silver; noble or non-noble metal plated non-metals such as silver or nickel-plated graphite, glass, ceramics, plastics, elastomers, or mica; electrically-conductive non-metals such as graphite or other carbons; and mixtures or blends of combinations of the foregoing. The filler, mixture, or blend is broadly classified as “particulate” in form, although the particular shape of such form is not considered critical to the present invention, and may include any shape that is conventionally involved in the manufacture or formulation of conductive materials of the type herein involved including hollow or solid microspheres, elastomeric balloons, flakes, platelets, fibers, rods, irregularly-shaped particles, or a mixture thereof. Similarly, the particle size of the filler is not considered critical, and may be or a narrow or broad distribution or range, but in general will be between about 0.250-250 μm, and more typically between about 1-100 μm.

The filler is loaded in the composition in a proportion sufficient to provide the level of electrical conductivity and EMI shielding effectiveness in the tape 10 which is desired for the intended application. For most applications, the filler proportion will generally be between about 10-80% by volume or 5-90% by weight, based on the total volume or weight, as the case may be, of the admixture. As adhered to the substrate, tape 10 itself, with an aluminum or other metal foil backing layer 20, and with an acrylic PSA-based adhesive layer 22 being filled with electrically-conductive particles, typically will exhibit a through resistance under 5 psi of less than about 10 m Ω/in² such as in accordance with CHO-TP-57 (Chomerics Test Procedure, Parker Chomerics Division, Woburn, Mass.) equivalent to MIL-STD-202C. Such resistance values generally will correspond to an EMI shielding effectiveness of at least 10 dB, and usually at least 20 dB, and preferably at least about 60 dB or higher, over a frequency range of from about 10 MHz to 10 GHz. As is known, however, the ultimate shielding effectiveness of tape 10 will vary based on the amount and type of the electrically-conductive filler, on the thicknesses of the backing and adhesive layers 20 and 22, and on the material of construction of backing layer 20. As is also known, comparable EMI shielding effectiveness may be achieved at lower conductivity levels through the use of an EMI absorptive or “lossy” filler such as ferrites or nickel-coated graphites.

Additional fillers and additives may be included in the PSA composition depending upon the requirements of the particular application envisioned. Such fillers and additives may include conventional wetting agents or surfactants, pigments, dyes, and other colorants, opacifying agents, anti-foaming agents, anti-static agents, coupling agents such as titanates, chain extending oils, tackifiers, pigments, lubricants, stabilizers, emulsifiers, antioxidants, thickeners, thermally-conductive fillers such as alumina or born nitride, and/or flame retardants such as aluminum trihydrate, antimony trioxide, metal oxides and salts, intercalated graphite particles, phosphate esters, decabromodiphenyl oxide, borates, phosphates, halogenated compounds, glass, silica, silicates, and mica. Typically, these fillers and additives are blended or otherwise admixed with the formulation, and may comprise between about 0.05-80% or more by total volume thereof.

In the production of commercial quantities of the tape 10, the formulation for the adhesive layer 22 may be compounded in a conventional mixing apparatus as an admixture of the PSA composition, the electrically-conductive filler, and any additional fillers and/or additives. Depending upon the PSA composition, water or another solvent or diluent, which may be organic or inorganic, may be added to control the viscosity of the fluent admixture which may be adjusted for the application equipment or process to be used. The formulation may be coated or otherwise applied to the side 26 of the backing layer 20 in a conventional manner such as, for example, by a direct process such as spraying, knife coating, roller coating, casting, drum coating, dipping, dispensing, extrusion, screen printing, or like, or an indirect transfer process. After coating, the resultant material may be dried to flash the solvent or otherwise cured or cooled to develop an adherent film, residue, or other coating of the adhesive layer 22 on the backing layer 20. By “cured,” it is meant that the material of the applied layer 22 is polymerized, cross-linked, further cross-linked or polymerized, vulcanized, hardened, dried, or otherwise chemically or physically changed from a liquid, semi-liquid, semi-solid, or other fluent form into a generally solid phase. As a result of the inherent tack of the PSA composition, an adhesive and/or mechanical bond may be developed between the layers 20 and 22 to form the integral, laminate structure of tape 10. Alternatively, the adhesive layer 22 may be separately formed and laminated under conditions of elevated temperature and/or pressure to the backing layer 20 in a separate operation.

With continuing reference to FIGS. 1 and 2, for ease of handling and as a protective layer for shipping, release liner 24 may be provided over the outer face 32 of the adhesive layer 22. Exemplary release liners include face stocks or other films of polyolefins, plasticized polyvinyl chloride, polyesters, cellulosics, metal foils, composites, and waxed, siliconized, or other coated paper or plastic having a relatively low surface energy to be removable without appreciable lifting of the adhesive layer 22 from the backing layer 20. A continuous roll or other length of tape 10 may be supplied by adhering or otherwise laminating a length of the liner 24 to the adhesive layer 22 carried on a corresponding length of the backing layer 20.

The use of tape 10 of the invention is illustrated in connection the representative EMI shielding assembly for an electronic device which is referenced generally at 40 in the perspective view of FIG. 3. As depicted in FIG. 3, assembly 40 includes a first component or part, 42, which as is shown may be a base of a housing, cabinet, or enclosure of the device, and a second component or part, 44, which as is shown may be a cover for the base 42. Alternatively, one or both of the parts 42 and 44 may be a door, access panel, circuit board, frame, keypad, spacer, vent, back or face plane, shielding cap or can, I/O connector panel, or a base or cover of another indoor or outdoor housing, cabinet, or other enclosure. The electronic device itself may be, as is shown, a disk drive or, alternatively, a cellular telephone handset, personal communications services (PCS) handset, PCMCIA card, global positioning system (GPS), personal digital assistant (PDA), personal or laptop computer, or a radio receiver or transmitter, network server, cellular communication base station, or other telecommunications equipment. Each of the parts 42 and 44 may have an exterior surface, referenced at 46 and 48, respectively, which adjoins the other one of the surfaces 46 and 48 along the parting line or other seam referenced at 50. The parts 42 and 44 may be removably joined in the assembly 40 to form the enclosure referenced at 52 by means of screws, one of which is referenced at 54, or other fastening arrangement such as an interferingly-engaged, i.e., snap-fit, series of tabs and slots, clips, or the like.

Depending upon the specifications or other requirements of the intended application, parts 42 and 44 each may be cast, extruded, or injection or otherwise molded of, independently, a thermoplastic or other polymeric material such as a poly(ether ether ketone), polyimide, high molecular weight polyethylene, polypropylene, polyetherimide, polybutylene terephthalate, nylon, fluoropolymer, polysulfone, polyester, ABS, acetal homo or copolymer, or a liquid crystal polymer. In the case of an electrically-nonconductive material, the adjoining surfaces 42 and 44 may be painted, metallized, coated, sprayed, laminated, or otherwise provided with a metal or metal-filled coating layer. Alternatively, parts 42 and 44 each may be machined, molded, extruded, drawn, stamped, cast, die cast, or otherwise formed, independently, of a metal such as an aluminum, magnesium, or steel, with the surfaces 46 and 48 being formed thereof or of a plating or other coating of a different metal.

With the release liner 24 (FIGS. 1 and 2) having been removed to expose the inherently tacky outer face 32 of the adhesive layer 22, a continuous length or multiple strips of the tape 10, which may have been dispensed from a roll thereof, may be applied along the perimeter of the seam 50 to cover the seam and to thereby provide a low impedance path across the seam and otherwise for the EMI shielding and dust or other environmental sealing of the enclosure 52. In this regard, the outer adhesive face 32 (FIGS. 1 and 2) of the tape 10 may be bonded under pressure across the seam 50 so as to adhere to each of the respective part surfaces 46 and 48.

Should the enclosure 52 require disassembly for rework, repair, or otherwise, the length or lengths of tape 10 may be peeled, such as in the manner depicted at 60, or otherwise removed from the respective surfaces 46 and 48 of the enclosure parts 42 and 44. Advantageously, the removal of the tape 10 may be effected in a primarily adhesive failure mode whereby the break between the adhesive layer 22 and the part surfaces 46 and 48 is substantially “clean,” i.e., without appreciable adhesive residue on the surfaces 46 and 48 as may be confirmed by visual and/or tactile inspection. Such removal is to be contrasted with a primarily cohesive failure mode whereby the break would be within the adhesive layer itself as would leave an appreciable residue on the part surface. Thus, by virtue of the provision of the present invention, upon the reassembly of the enclosure 52, the surfaces 46 and 48 thereof need not be scraped, solvent-wiped, or otherwise cleaned of adhesive residue prior to the reapplication of the tape 10 which may be same strip or strips removed or which may be provided as one or more a new strips.

The Example to follow is illustrative of the practicing of the invention herein involved, but should not be construed in any limiting sense.

### EXAMPLE

A layer of a solvent-based, acrylic PSA filled with conductive particles was coated at a thickness of about 2 mils (0.05 mm) onto one side of several strips of 2 mil (0.05 mm) thick aluminum foil. The samples so prepared were adhered using an applied pressure obtained by rolling with a 10 pound (4.5 kg) roller at 12 in/min (30.5 cm/min) once in each lengthwise direction onto stainless steel substrates for 180° peel (PSTC-1) and shear (PSTC-7) adhesion testing. The peel testing was performed at increasing dwell times and at elevated temperatures. The peel adhesion results are shown in Table 1 and the shear adhesion results are shown in Table 2, with the letter “A” in each table denoting an adhesive failure to the substrate, i.e., a “clean break,” and the letter “C” denoting a cohesive failure within the adhesive layer, i.e., a non-clean break as would be shown by adhesive residue on the substrate. For purposes of comparison, the results for a comparable conventional, non-cleanly removable tape (CHO-FOL®, Chomerics Division of Parker Hannifin Corporation, Woburn, Mass.) representative of the prior art are also shown in Table 1.

TABLE 1
180° Peel Adhesion Testing (PSTC-1)

| | Adhesion | Average Adhesion | % Change | Cho-Foil ® Adhesion | % Change |
|---|---|---|---|---|---|
| Dwell @ Temp. | lb/in (N/m) | lb/in (N/m) | (from initial) | lb/in (N/m) | (from initial) |
| 15 min @ RT* | 2.42-A (424) | 2.44 (427) | N/A | 2.62-A (459) | N/A |
| | 2.38-A (417) | | | | |
| | 2.52-A (441) | | | | |
| 1 hr @ RT* | 2.44-A (427) | 2.34 (410) | −4.1% | | |
| | 2.59-A (454) | | | | |
| | 1.99-A (349) | | | | |
| 24 hrs @ RT* | | | | 3.20-A (564) | 23% |
| 1 week @ RT* | 3.38-A (592) | 3.16 (554) | 30% | | |
| | 3.14-A (550) | | | | |
| | 3.55-A (622) | | | | |
| | 2.56-A (449) | | | | |
| 500 hr @ RT* | 3.51-A (615) | 3.69 (646) | 51% | 4.59-A/C (804) | 75% |
| | 3.87-A (678) | | | | |
| | 3.69-A (646) | | | | |
| 500 hr @ 65° C. | 4.08-A (714) | 3.68 (645) | 51% | 7.96-C (1395) | 204% |
| | 3.72-A (652) | | | | |
| | 3.25-A (569) | | | | |

*Room Temperature

TABLE 2
Shear Adhesion Testing (PSTC-7)

| Pressure | | |
|---|---|---|
| psi (MPa) | Hours | Average Hours |
| 8.8 (0.06) | 9.9-A* | 7.8 |
| | 5.6-A* | |

*slight “ghosting” of adhesive residue on substrate

The foregoing results confirm that the tape of the present invention exhibits good initial peel and shear adhesion to housing substrate, and an acceptable build on aging of less than about 50%. These results also confirm that the tape of the invention is cleanly releasable from housing substrates. In this regard, as compared to conventional, non-cleanly releasable tapes, the tape of the invention exhibits a generally lower peel adhesion, particularly after aging, and, importantly, a primarily adhesive failure mode in contrast to the primarily cohesive failure mode exhibited by conventional tapes after aging.

As it is anticipated that certain changes may be made in the present invention without departing from the precepts herein involved, it is intended that all matter contained in the foregoing description shall be interpreted as illustrative and not in a limiting sense. All references cited herein are expressly incorporated by reference.

What is claimed is:

1. An EMI shielding tape adherable under pressure to a surface of a structure, said tape comprising:
a backing layer having a first side and a second side opposite said first side; and
an adhesive layer carried on at least one of said first and said second side of said backing layer, said adhesive layer having an inner face bonded to said one of said first and said second side of said backing layer, and an outer face opposite said inner face bondable under pressure to the structure surface to adhere said tape thereto, said adhesive layer comprising an admixture of a pressure sensitive adhesive (PSA) composition and one or more electrically-conductive particulate fillers,
whereby said tape when adhered to the structure surface is substantially cleanly releasable therefrom.

2. The tape of claim 1 wherein said first and said second side of said backing layer define a thickness dimension of said backing layer therebetween of between about 0.5-8.0 mils (0.013-0.203 mm).

3. The tape of claim 1 wherein said inner and said outer face of said adhesive layer define a thickness dimension of said adhesive layer therebetween of between about 0.05-2.5 mils (0.013-0.064 mm).

4. The tape of claim 1 wherein said tape when adhered to the structure surface exhibits an EMI shielding effectiveness of at least about 60 dB substantially over a frequency range of between about 10 MHz and about 10 GHz.

5. The tape of claim 1 wherein said tape has an electrical through resistance when adhered to the structure surface of not greater than about 50 m Ω/in² (7.8 m Ω/cm²).

6. The tape of claim 1 wherein said backing layer is formed of an electrically-conductive material selected from the group consisting of metal foils and metal-plated fabrics.

7. The tape of claim 1 wherein the structure surface comprises a metal.

8. The tape of claim 1 wherein said tape when adhered to the structure surface exhibits an initial peel strength of between about 1.5-5.0 lb/in (0.26-0.87 N/m) thereon.

9. The tape of claim 8 wherein said peel strength increases on aging by less than about 50%.

10. The tape of claim 1 wherein said PSA composition comprises one or more homopolymers or copolymers of an acrylic or methacrylic acid, ester, amide, or nitrile, or a blend thereof.

11. The tape of claim 1 wherein said admixture comprises between about 5-90% by weight of said one or more electrically-conductive particulate fillers.

12. The tape of claim 1 wherein the second side of said backing layer is treated to increase the affinity of said adhesive layer thereto relative to the surface of the structure.

13. An EMI shielding enclosure assembly for housing circuitry of an electronic device, said assembly comprising:
first enclosure part having a first surface;
a second enclosure part having a second surface adjoining said first surface, said first and said second surface having a seam of a given length therebetween; and
an EMI shielding tape covering at least a portion of the length of said seam, said tape comprising:
a backing layer having a first side and a second side opposite said first side; and
an adhesive layer carried on at least one of said first and said second side of said backing layer, said adhesive layer having an inner face bonded to said one of said first and said second side of said backing layer, and an outer face opposite said inner face bonded under pressure across said seam to said first and said second surface adhering said tape thereto, said adhesive layer comprising an admixture of a pressure sensitive adhesive (PSA) composition and one or more electrically-conductive particulate fillers,
whereby said tape is substantially cleanly releasable from one or both said first and second surface.

14. The assembly of claim 13 wherein said first and said second side of said backing layer of said tape define a thickness dimension of said backing layer therebetween of between about 0.5-8.0 mils (0.013-0.203 mm).

15. The assembly of claim 13 wherein said inner and said outer face of said adhesive layer of said tape define a thickness dimension of said adhesive layer therebetween of between about 0.05-2.5 mils (0.013-0.064 mm).

16. The assembly of claim 13 wherein said tape exhibits an EMI shielding effectiveness of at least about 60 dB substantially over a frequency range of between about 10 MHz and about 10 GHz.

17. The assembly of claim 13 wherein said tape has an electrical through resistance of not greater than about 50 m Ω/in² (7.8 m Ω/cm²).

18. The assembly of claim 13 wherein said backing layer of said tape is formed of an electrically-conductive material selected from the group consisting of metal foils and metal-plated fabrics.

19. The assembly of claim 13 wherein one or both of said first and said second surface comprises a metal.

20. The assembly of claim 13 wherein said tape exhibits an initial peel strength from said first and second surface of between about 1.5-5.0 lb/in (0.26-0.87 N/m) thereon.

21. The assembly of claim 20 wherein said peel strength increases on aging by less than about 50%.

22. The assembly of claim 13 wherein said PSA composition of said adhesive layer of said tape comprises one or more homopolymers or copolymers of an acrylic or methacrylic acid, ester, amide, or nitrile, or a blend thereof.

23. The assembly of claim 13 wherein said admixture of said adhesive layer of said tape comprises between about 5-90% by weight of said one or more electrically-conductive particulate fillers.

24. The assembly of claim 13 wherein the second side of said backing layer is treated to increase the affinity of said adhesive layer thereto relative to one or both of said first and said second surface.

25. A method of removably covering a seam having a length within an EMI shielding enclosure for housing circuitry of an electronic device, said seam being formed between a first surface of a first enclosure part and an adjoining second surface of a second enclosure part, said method comprising the steps of:
(a) providing an EMI shielding tape comprising:
a backing layer having a first side and a second side opposite said first side; and
an adhesive layer carried on at least one of said first and said second side of said backing layer, said adhesive layer having an inner face bonded to said one of said first and said second side of said backing layer, and an outer face opposite said inner face, said adhesive layer comprising an admixture of a pressure sensitive adhesive (PSA) composition and one or more electrically-conductive particulate fillers; and
(b) bonding under pressure the outer face of said adhesive layer of said tape across said seam to said first and said second surface adhering said tape thereto, said tape covering at least a portion of the length said seam,
whereby said tape is further provided to be substantially cleanly releasable from one or both said first and said second surface.

26. The method of claim 25 wherein said first and said second side of said backing layer of said tape define a thickness dimension of said backing layer therebetween of between about 0.5-8.0 mils (0.013-0.203 mm).

27. The method of claim 25 wherein said inner and said outer face of said adhesive layer of said tape define a thickness dimension of said adhesive layer therebetween of between about 0.05-2.5 mils (0.013-0.064 mm).

28. The method of claim 25 wherein said tape exhibits an EMI shielding effectiveness of at least about 60 dB substantially over a frequency range of between about 10 MHz and about 10 GHz.

29. The method of claim 25 wherein said tape has an electrical through resistance of not greater than about 50 m Ω/in² (7.8 m Ω/cm²).

30. The method of claim 25 wherein said backing layer of said tape is formed of an electrically-conductive material selected from the group consisting of metal foils and metal-plated fabrics.

31. The method of claim 25 wherein one or both of said first and said second surface comprises a metal.

32. The method of claim 25 wherein said tape exhibits an initial peel strength from said first and second surface of between about 1.5-5.0 lb/in (0.26-0.87 N/m) thereon.

33. The method of claim 32 wherein said peel strength increases on aging by less than about 50%.

34. The method of claim 25 wherein said PSA composition of said adhesive layer of said tape comprises one or more homopolymers or copolymers of an acrylic or methacrylic acid, ester, amide, or nitrile, or a blend thereof.

35. The method of claim 25 wherein said admixture of said adhesive layer of said tape comprises between about 5-90% by weight of said one or more electrically-conductive particulate fillers.

36. The method of claim 25 further comprising the additional step:
(c) removing said tape from said first and said second surface.

37. The method of claim 25 wherein the second side of said backing layer of said tape provided in step (a) is treated to increase the affinity of said adhesive layer thereto relative to one or both of said first and said second surface.
